(19) United States
(12) Patent Application Publication
(10) Pub. No.: US 2014/0317333 A1
(43) Pub. Date: Oct. 23, 2014

(54) Direct Memory Access Controller with Hybrid Scatter-Gather Functionality

(71) Applicant: Microchip Technology Incorporated, Chandler, AZ (US)

(72) Inventors: Jeffrey R. Dorst, Austin, TX (US); Xiang Liu, Austin, TX (US)

(21) Appl. No.: 14/254,256

(22) Filed: Apr. 16, 2014

Related U.S. Application Data
(60) Provisional application No. 61/812,873, filed on Apr. 17, 2013.

(51) Int. Cl. G06F 13/28

(52) U.S. Cl. CPC G06F 13/28
USPC 710/308

(57) ABSTRACT

A direct memory access (DMA) controller stores a set of DMA instructions in a list, where each entry in the list includes a bit field that identifies the type of the entry. Based on the bit field, the DMA controller determines whether each DMA instruction is a buffer pointer or a jump pointer. If a DMA instruction is identified as a buffer pointer, the DMA controller transfers data to or from the location specified by the buffer pointer. If a DMA instruction is identified as a jump pointer, the DMA controller jumps to the location in the list specified by the jump pointer. A subset of the list of DMA instructions may be cached, and the DMA controller executes the cache entries sequentially. If a jump pointer is encountered in the cache, the DMA controller flushes the cache and reloads it from main memory based on the jump pointer.

### CROSS-REFERENCE TO RELATED APPLICATIONS

This application claims the benefit of U.S. Provisional Application No. 61/812,873 filed on Apr. 17, 2013, which is incorporated herein in its entirety.

### TECHNICAL FIELD

The present disclosure relates to direct memory access controllers; in particular, a multi-channel, scatter-gather direct memory access controller.

### BACKGROUND

Direct memory access (DMA) controllers are used by computer systems to perform data transfers between memory and hardware subsystems, where the transfer is completed independently from the central processing unit of the computer system. Computer systems may utilize multiple DMA controllers and may include sub-components such as microcontrollers, microprocessors, embedded systems, and peripherals that themselves implement DMA controllers. A DMA controller brokers direct access to data stored in memory, which may otherwise require interrupting the system processor to execute the transfer. This capability provided by a DMA controller is especially advantageous in situations where the hardware subsystem will process the retrieved data itself, in which case the system processor only transfers the data and does not process it. For instance, a graphics card may need to access data stored in the system memory. But since the graphics card will be processing the retrieved data itself, DMA allows the data to be retrieved by the graphics card while bypassing the system processor. This frees up cycles on the system processor and generally improves efficiency because the processor is not waiting on relatively slow I/O operations.

A DMA controller implements the logic for handling the memory transfers between DMA-enabled hardware subsystems. A DMA controller can typically support memory access for multiple subsystems concurrently via multiple channels. In order to provide this capability, a DMA controller implements the logic for managing the multiple channels concurrently. Thus, the DMA controller can be viewed as a special-purpose processing unit that manages direct access to system memory via a defined set of channels. Despite the limited set of responsibilities of the DMA controller, conventional DMA controllers include inefficiencies.

Generally, a DMA controller is instructed to transfer a specific set of data from a source location to a destination location via a specific channel. The source and destination locations can be within system memory (typically RAM) or data memory of a microcontroller, embedded system of a peripheral device, or other data accessible by a peripheral (such as data from an analog-to-digital converter, a port, a capture compare unit, etc.). In order to transfer data from a source location to a destination location, a conventional DMA controller receives the respective source and destination addresses as part of a transfer instruction. One way this address information is provided to the DMA controller is in the form of “descriptors” that are supported by the DMA controller, where each descriptor is an instruction directing the DMA controller. In conventional systems, each descriptor directs the DMA controller to transfer a contiguous block of data between a specified location in system memory and data memory. In order to identify the block of memory to be transferred, a conventional descriptor may also specify the size of the block as part of the data transfer instruction. The source address and the block size are used by a conventional DMA controller to identify the contiguous block of data to be transferred from system memory.

Descriptors are provided to a DMA controller organized into lists, with each entry in the lists being a descriptor that directs an action by the DMA controller. The list of descriptors can be executed strictly sequentially by the DMA controller or executed in any order if the list is a linked list where each entry has an additional dedicated pointer that specifies another entry in the list as the next descriptor to be executed. It is generally more efficient to transfer streaming data (i.e., unstructured data which is usually stored in contiguous blocks of memory) using a sequentially executed list of descriptors rather than using a linked list of descriptors. However, the transfer of packet data (i.e., structured data that tends to require processing of each individual data item stored in dispersed locations in memory) tends to favor the flexibility provided by a linked list. Consequently, a DMA controller typically supports both sequential and non-sequential processing of descriptor lists. In order to support both types of processing, conventional DMA controllers utilize linked lists of descriptors configured to utilize pointers in all instances, which results in expending significant addressing overhead that is largely unneeded when transferring streaming data. Thus, there exists a need for a more flexible DMA controller that can handle various types of data transfers in an efficient manner.

### SUMMARY

Conventional DMA controllers use linked lists of DMA descriptors for both sequential and non-sequential processing of descriptors. Depending on the nature of the data being transferred, sequential processing does not provided sufficient flexibility, and conventional linked lists may include significant wasted overhead. Hence, there is a need for hybrid linked list that provides the advantages of both sequential and linked lists. These and other drawbacks in the prior art are overcome in large part by a system and method according to embodiments of the present invention.

According to an embodiment, a DMA controller is comprised of a control unit a configured to perform a data transfer over a bus coupled with the DMA controller, wherein the control unit is further configured to perform a plurality of data transfers using one or more lists of DMA instructions stored in memory, and wherein the control unit will read address information from each list entry, and wherein the address information is determined to be either a buffer pointer or a jump pointer based on at least one bit within each list entry.

According to a further embodiment, the DMA controller is further comprised of a cache of DMA instructions called descriptors, wherein the control unit loads a block of descriptors into the cache and wherein the control unit sequentially executes the descriptors stored in the cache. According to a further embodiment, the control unit of the DMA controller flushes the cache when the cache entry to be executed is identified as a jump descriptor. According to a further embodiment, each descriptor comprises a first and second bit field, wherein the first bit field stores said address information, and the second bit field stores the one or more bits that indicate whether the address information provides a buffer pointer or a jump pointer. According to a further embodiment, the buffer pointer comprises a start address that identifies the beginning of a contiguous block of data memory to be transferred by the controller. According to a further embodiment, the buffer pointer further comprises a buffer depth (BD) value that specifies the size of the contiguous block of data memory to be transferred.

### BRIEF DESCRIPTION OF THE DRAWINGS

The present invention may be better understood, and its numerous objects, features, and advantages made apparent to those skilled in the art, by referencing the accompanying drawings. The use of the same reference symbols in different drawings indicates similar or identical items.

FIG. 1 is a block diagram illustrating a high-level computer architecture of a computer system that includes a DMA controller according to embodiments of the invention.

FIG. 2 is a block diagram illustrating the operation of a DMA controller according to embodiments of the invention.

FIG. 3 is a block diagram illustrating the operation of conventional DMA controllers that implements a sequential list of descriptors.

FIG. 4 is a block diagram illustrating the operation of a conventional DMA controller that implements a linked lists of descriptors.

FIG. 5 is a block diagram illustrating the operation of a DMA controller that implements a hybrid linked list of descriptors according to embodiments of the invention.

FIGS. 6A and 6B are a block diagram illustrating how a hybrid linked list can be used to implement descriptor lists from fully sequential, to fully linked, to any hybrid sequential/linked lists in between given the hybrid linked list addressing scheme according to embodiments of the invention.

### DETAILED DESCRIPTION

According to various embodiments, improved efficiency is provided by replacing conventional DMA descriptors with two distinct types of descriptors: one type supporting sequential execution of a list of descriptors, and the other type supporting the use of pointers in the non-sequential execution of lists of descriptors. And, according to various embodiments, the DMA controller utilizes two types of descriptors in a manner that allows efficient switching between sequential and non-sequential processing of descriptors. Thus, a DMA controller with a more flexible and efficient set of transfer capabilities can be provided.

According to various embodiments, a DMA controller balances the need to provide the flexibility of both sequential and non-sequential processing, while also maintaining efficient use of memory and bus bandwidth. Additionally, according to some embodiments, the user is provided the ability to configure individual channels of the DMA controller to better support either sequential or non-sequential processing of descriptors based on the characteristics of the data being transferred.

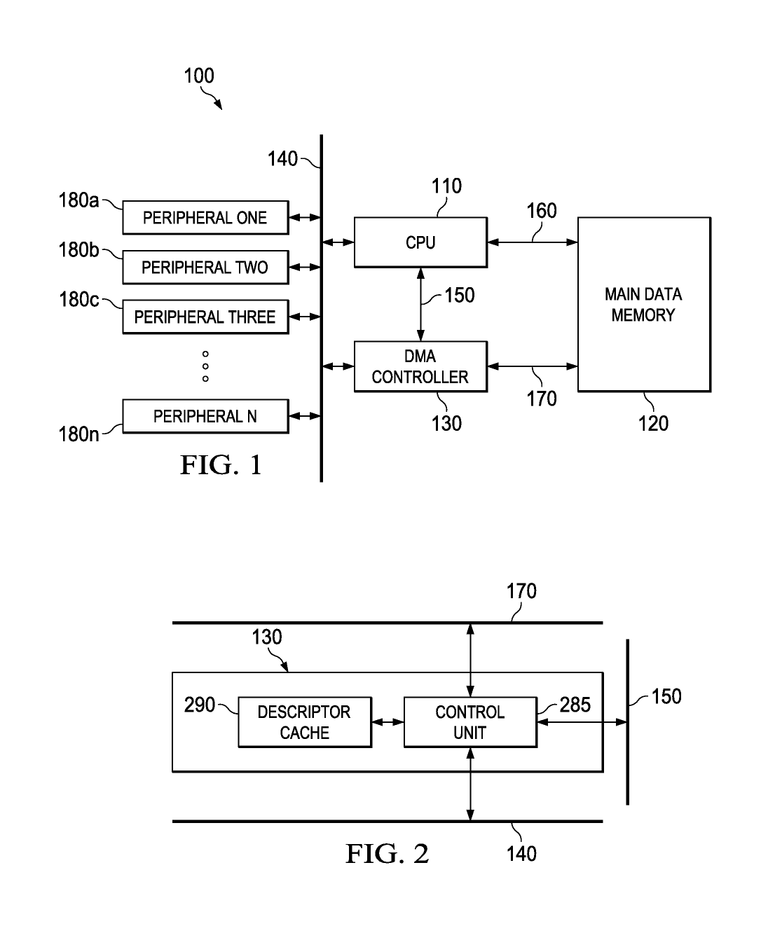

FIG. 1 depicts an illustrative embodiment of a DMA controller within a computer system, such as a microcontroller or an embedded system. A computer system 100 generally comprises a central processing unit (CPU) 110, which is coupled to one or more communication buses. In the embodiment illustrated in FIG. 1, a peripheral bus 140 is shown. Through this peripheral bus 140, the CPU 110 can communicate with a plurality of peripheral devices 180a . . . 180n, such as I/O ports, memories, A/D and D/A converters, timers, pulse width modulators, graphics subsystems, audio processing subsystems, etc. Furthermore, a memory bus 160 can be provided to couple the CPU 110 with a main data memory 120, such as RAM memory. A DMA controller 130 is coupled with the peripheral bus 140 to provide data transfer between the DMA-capable peripheral devices 180a . . . 180n coupled with this bus 140. In addition, the DMA controller 130 is coupled through a memory bus 170 with a data memory 120. The DMA controller 130 may also include a connection 150 with the CPU 110, by which the DMA controller can receive control signals from the CPU.

The system depicted in FIG. 1 allows the DMA controller 130 to broker transfers between data memory 120 and the peripheral devices 180a . . . 180n without burdening the CPU 110. This system can also be used to execute data transfers strictly within data memory 120, also without burdening the CPU 110. Typically, the CPU 110 will be needed to initialize the DMA controller 130. But once the DMA controller 130 has been initialized, transfers to and from data memory 120 may be conducted without the aid of the CPU 110. This frees the CPU 110 to perform other tasks. In particular, it frees CPU 110 from the delay caused by brokering relatively slow I/O transactions that require accessing memory.

FIG. 2 shows a DMA controller 130 according to embodiments. The DMA controller supports multiple channels that can be independently configured via control signal received from CPU 110 via connection 150. One configurable aspect of these channels is that each channel is specified as being either a transmit or a receive channel. A receive channel is used by the DMA controller 130 to move data from a device on the peripheral bus 140 to the main data memory bus 170. Conversely, a transmit channel is used to move data from main data memory bus 170 to a device on the peripheral bus 140. The DMA controller 130 receives one or more lists of descriptors from the CPU 110. Each channel is configured to execute a list of descriptors.

According to embodiments each descriptor in a hybrid linked list is either a buffer descriptor that specifies an address in system memory to be transferred or a jump descriptor that is pointer to another descriptor in a descriptor list. Each descriptor further includes a control bit field used to specify whether the descriptor is a buffer descriptor or a jump descriptor. The DMA controller 130 uses the control bit field to decode the type of a descriptor so that the controller can process the descriptor accordingly.

If a descriptor is determined to be a buffer descriptor, the DMA controller 130 accesses the location in main data memory 120 specified by the buffer descriptor. If a buffer descriptor is executed within a transmit channel, the DMA controller 130 retrieves the data located in main data memory at the address specified by the buffer descriptor via memory bus 170 and transfers the data to the peripheral device making the transfer request via peripheral bus 140. If the buffer descriptor is executed within a receive channel, the DMA controller 130 receives the data from a peripheral device via peripheral bus 140 and stores the data to the location in main data memory 120 at the address specified by the buffer descriptor via memory bus 170.

In some embodiments, the data being transferred resides in an external memory location such that both read and write operations by the DMA controller 130 are via peripheral bus 140. In some embodiments, transfer operations will be within main data memory such that the DMA controller transfers data from one location in main data memory to another location in main data memory via memory bus 170.

In some embodiments, the control unit 285 of the DMA controller accesses lists of descriptors stored in main data memory 120. Each time the control unit 285 completes execution of a descriptor and is ready to begin execution of a new descriptor, the control unit retrieves the next descriptor from main data memory 120. If the completed descriptor is a buffer descriptor, the next descriptor fetched from main data memory 120 by the control unit 285 is the next descriptor in main data memory in the list being executed. If the completed descriptor is a jump descriptor, the jump pointer of the jump descriptor specifies the address in main data memory 120 of the next descriptor to be fetched by the control unit 285.

In some embodiments, the control unit 285 of the DMA controller 130 receives one or more descriptor lists and stores these lists in the descriptor cache 290. The control unit 285 begins execution of a cached descriptor list by processing the first descriptor in the list. As described above, the control unit 285 interrogates the descriptor being processed to determine whether it is a buffer descriptor or a jump descriptor. After a descriptor has been executed and the control unit 285 is ready to process the next descriptor, the next descriptor is fetched from a list in descriptor cache 290. If the executed descriptor is a buffer descriptor, the control unit 285 fetches the descriptor located at the next location in the descriptor cache 290. If the executed descriptor is a jump descriptor, the jump pointer of the jump descriptor specifies the address in main data memory 120 of the next descriptor to be fetched by the control unit 285. Embodiments utilizing descriptor cache 290 are able to operate more efficiently than relying on lists stored in main data memory 120 because maintaining a descriptor cache 290 in the DMA controller allows main data memory 120 data transfers to be executed without the controller interrupting the transfers in order to retrieve additional descriptors from main data memory 120.

As described above, descriptors are typically provided to a conventional DMA controller in the form of lists, where each list is implemented as a linked list. Each element in a conventional list is a descriptor that specifies a contiguous block of data memory to be transferred. In addition to specifying the address of the data to be transferred, using a linked list implementation also requires that each descriptor include a pointer to the next descriptor to be executed. This linked list implementation allows for the descriptors to be executed in any order and for repeating patterns of descriptors to be executed. However, use of a conventional linked list can result in significant inefficiencies.

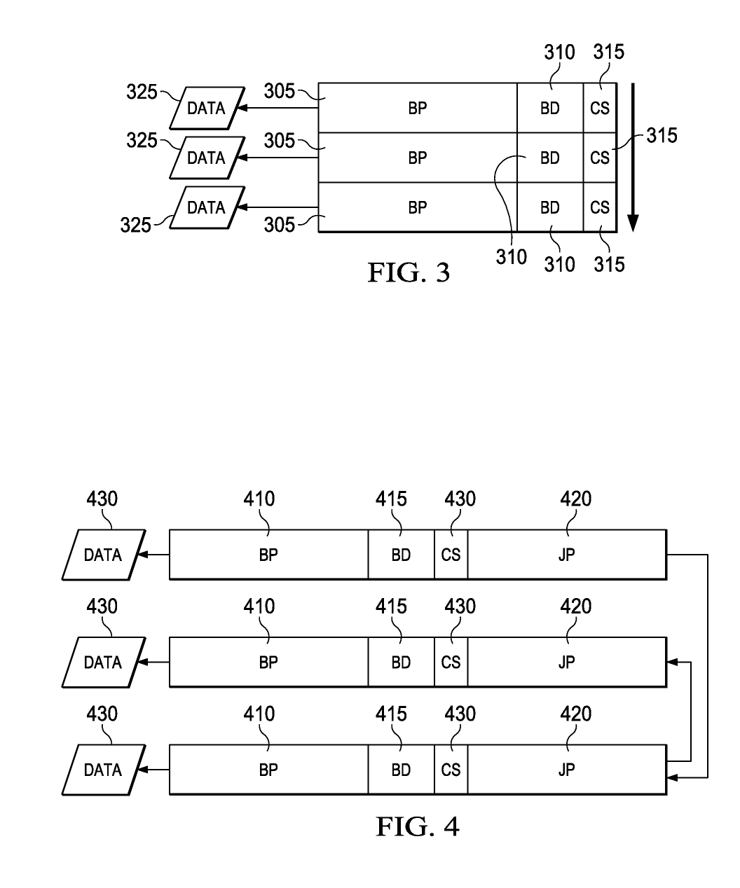

FIG. 3 depicts a conventional list of descriptors, where the descriptors are processed strictly in the order they appear in the contiguous memory that stores the list. As illustrated in FIG. 3, each descriptor in this sequential list may be comprised of a buffer pointer (BP) 305, which specifies the starting memory address of the block of data to be transferred, a buffer depth (BD) 310 and one or more control status (CS) bits 315. The buffer depth 310 is used as an offset from the buffer pointer 305 to determine the entire block of data to be transferred. As illustrated, a conventional DMA controller would execute the first descriptor in the sequential list by retrieving the block of data specified by the buffer pointer 305 and the buffer depth 310 for this first descriptor. Once completed, the DMA controller would then move on to the next descriptor in the sequential list. Such a sequential list would be suited for the transfer of large, contiguous blocks of data, such as the case for transfer of streaming data. However, without jump pointers, a sequential list cannot utilize retrieval patterns such as circular or ping-pong buffers that have been demonstrated to provide efficient data transfers for non-streaming data.

FIG. 4 depicts a conventional linked list of descriptors. In a linked list, every descriptor includes both a data transfer instruction and a jump instruction. More specifically, a conventional descriptor includes a jump pointer 420 which specifies the next descriptor to be executed, a buffer pointer (BP) 410, a buffer depth (BD) 415 and one or more control status bits 430. For a linked list, the descriptors in the list are executed by the DMA controller based on the order set forth by the jump pointers 420 specified in each descriptor. In executing each conventional descriptor, the DMA controller accesses the memory location specified by the buffer pointer 410. Once the block of data specified by the buffer pointer 410 and the buffer depth 415 has been transferred, the DMA controller executes the jump instruction portion of the conventional descriptor. Each jump instruction is a jump pointer 420 that is a reference to another descriptor in a linked list. In this manner, the DMA controller traverses the conventional linked list in an order specified by the jump pointers. Due to this ability to jump between non-sequential blocks of descriptors, a linked list is well suited for the transfer of fragmented blocks of data, such as the case for transfers of packet data.

Unlike sequential lists, linked lists can be used to form data structures of descriptors within descriptor lists. Linked lists allow the DMA controller to piece together descriptors from non-contiguous blocks of memory. The use of jump pointers to read non-contiguous descriptors allows the linked list to define data structures that are used to provide efficient data transfers. For example, jump pointers are used by linked lists to define patterns of data transfers, such as ping-pong buffers, circular buffers, and other patterns known in the art. Such patterns are used to implement efficient data transfer algorithms. This capability provided by linked lists is both flexible and powerful, but it is also costly.

In order to provide these capabilities, linked lists require the use of jump pointers. Conventional linked lists utilize a jump pointer as a part of every descriptor, which adds to the size of the descriptor. The size of the descriptor is determined by the information that must be encoded within the descriptor. The size of the buffer pointer and jump pointer in a descriptor is dependent on the addressable size of the memory systems being accessed, typically 32 or 64 bits. Additional bits are needed in the descriptor to define buffer depth and control status bits. The number of bits needed to encode a jump pointer will vary depending on the size of the main memory 120 in which descriptor lists are stored. Including a jump pointer in every descriptor thus requires increasing the size of linked list descriptors when compared to descriptors used in sequential lists, such as that depicted in FIG. 3.

In addition, conventional linked lists that use a jump pointer in every descriptor are burdened by the significant computational overhead and memory bus bandwidth imposed by the jump pointers. In conventional linked lists, executing every descriptor requires first reading the jump pointer address, locating the descriptor that is referenced by the pointer, and fetching the next descriptor. These steps must be carried out for executing every descriptor, even if the jump pointer only points to the next entry in the list. Thus, additional instructions by the DMA controller are required to fetch and execute each linked list descriptor when compared to sequential lists.

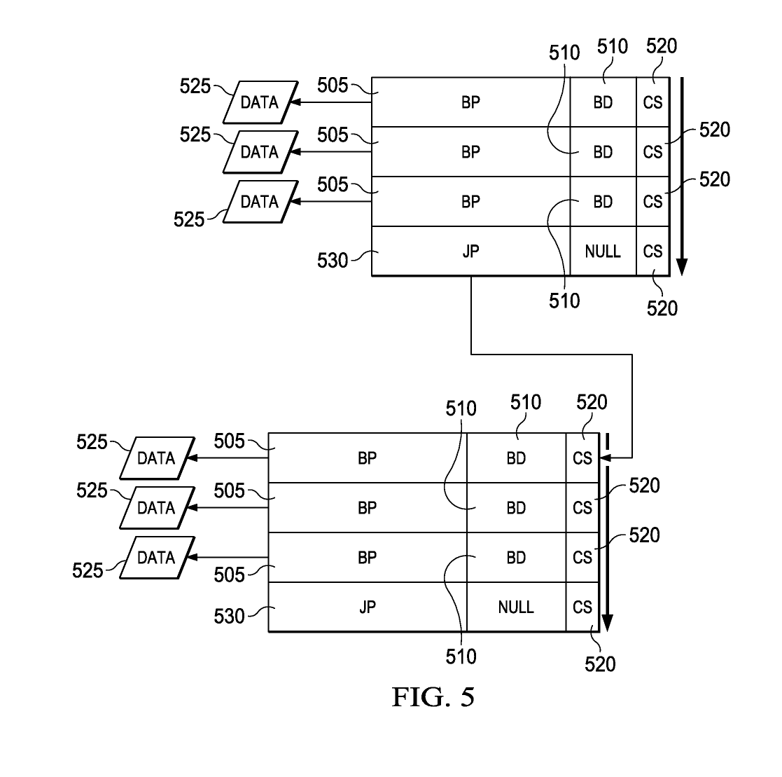

A hybrid linked list according to embodiments is shown in FIG. 5. Like a sequential list, the descriptors of a hybrid linked list are executed by the DMA controller in the order in which they appear in the list currently being executed for a channel. Sequential execution of descriptors continues until a jump descriptor is encountered in the list. As illustrated in FIG. 5, each entry in a hybrid linked list is comprised of either a buffer descriptor that contains a buffer pointer (BP) 505 or a jump descriptor that contains a jump pointer (JP) 530. The DMA controller determines whether an individual descriptor is a buffer descriptor or a jump descriptor by querying the descriptor's control status (CS) bit field 520 which encodes the “type” (e.g., buffer or jumper) of the descriptor. Each hybrid linked list descriptor also contain a buffer depth 610, that in conjunction with the buffer pointer 505, specifies the block of data to be transferred.

A hybrid linked list of descriptors, such as that illustrated in FIG. 5, is executed by the DMA controller in the order the descriptors in the memory where the list is stored, until a jump pointer is encountered in the list. If the DMA controller 130 determines that the next descriptor in the list to be executed is a buffer descriptor, then as described with respect to FIG. 2, the DMA controller 130 accesses the memory location specified by the buffer pointer 605 of the buffer descriptor. Data is then either written to or read from the buffer pointer location depending on whether the channel is transmit or receive channel.

Once execution of a buffer descriptor has been completed, the DMA controller 130 proceeds to execute the next descriptor in memory where the list is stored. This process continues until all of the entries in the list have been executed by the DMA controller 130, or until the next descriptor to be executed is determined to be a jump descriptor. If a jump descriptor is encountered, the next descriptor executed by the DMA controller is the descriptor at the memory address specified by the jump pointer 530 of the jump descriptor. Since a jump descriptor does not specify a block of data to be transferred, one or more bit fields of a jump descriptor may be null values. For example, bit fields that would represent a buffer pointer or a buffer depth would be used for other purposes by a jump descriptor or filled with placeholder null values.

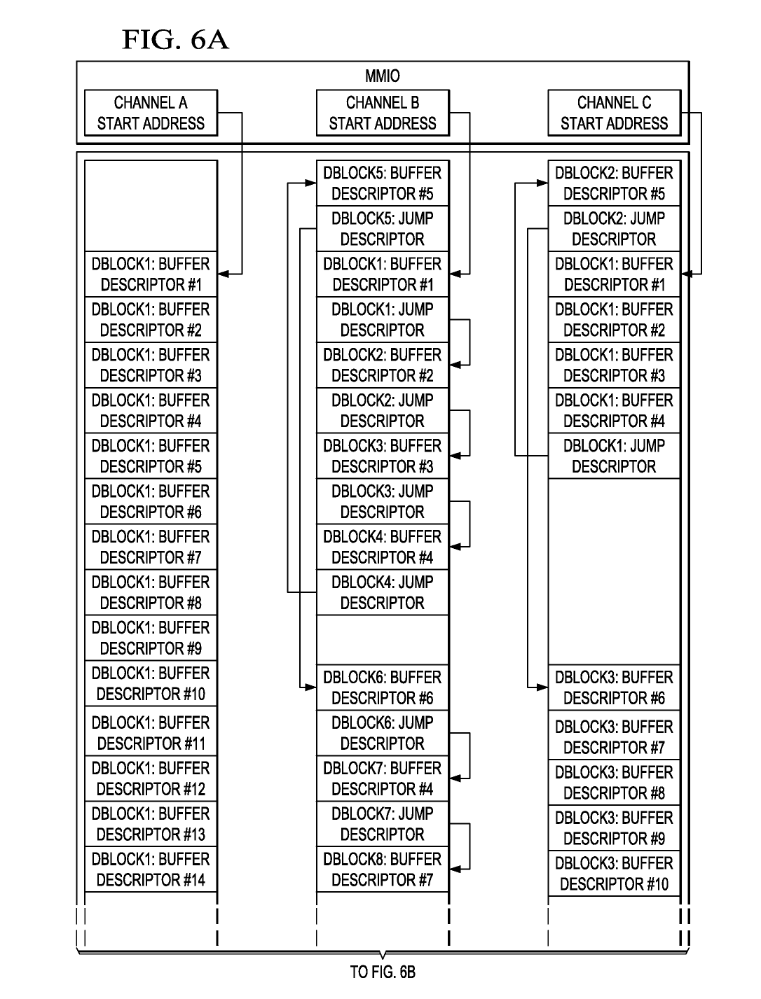

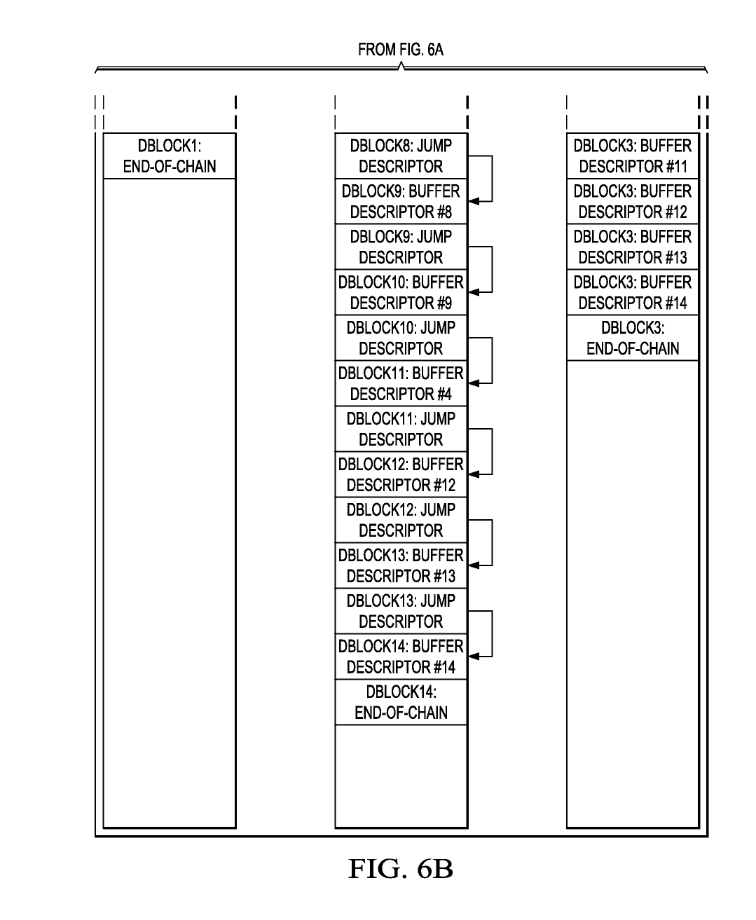

FIGS. 6A and 6B illustrate the ability of embodiments of the hybrid linked list to provide support for three different types of descriptor lists. The left column illustrates the implementation of a sequential list using a hybrid linked list embodiment. The center column illustrates the implementation of a linked list using a hybrid linked list embodiment. The right column illustrates the implementation of a hybrid list according to embodiments that combines both sequential and linked list processing capabilities. As illustrated in FIGS. 6A and 6B, hybrid linked lists according to embodiments can be used to construct both sequential and linked lists, as well as lists that are combinations of sequential and linked lists while also providing improved efficiency.

The center column of FIGS. 6A and 6B illustrate the use of a hybrid linked lists according to embodiments used to implement a linked list. FIGS. 6A and 6B further also illustrate the disadvantages of a conventional linked list. As discussed above, the execution of a conventional descriptor in a linked list requires that the DMA controller execute at least two operations. First, the DMA controller must execute a transfer instruction by transferring data to or from the address in main data memory that is specified by the descriptor. Second, the DMA controller must execute the jump instruction and determine the location of the next descriptor to be executed within one of the lists of descriptors. This is a significant source of overhead for the DMA controller, as simply executing jump instructions can constitute a significant portion of the controller's workload. This overhead becomes a particularly wasteful inefficiency when no jump instructions are needed because the descriptors can be executed in order that they appear in main data memory. In these cases, every jump instruction is just a pointer to the next entry in the list.

The left column of FIGS. 6A and 6B illustrate a sequential list implemented using a hybrid linked list according to embodiments. The DMA controller executes the descriptors of a hybrid linked list in the order the descriptors appear in main data memory. Consequently, the overhead attendant with jump descriptors is not spent. This improves efficiency since the DMA controller's operations are predominately data transfers when the hybrid linked list is mainly comprised of buffer descriptors. In addition to improving the efficiency of the DMA controller, a hybrid linked list also allows for smaller descriptors to be used compared to a conventional linked list. Depending on the number of bits required to represent jump pointers in the descriptor, a significant savings can be realized by sequential lists. The ability of a hybrid linked listed to process sequential blocks of descriptors also allows a DMA controller to realize other benefits with regards to efficiency. For descriptors in a sequential list arranged sequentially in main data memory, hardware can be configured to read larger contiguous blocks of descriptors and then cache them to reduce delays in retrieving descriptors. In addition, reading larger blocks of descriptors at once yields more efficient traffic on the bus.

The right column of FIGS. 6A and 6B illustrate a hybrid linked list according to embodiments that implements a list of descriptors that combines sequential and linked list properties. The hybrid linked lists offers the advantages of both sequential lists and linked lists, while providing improved efficiency over conventional linked lists. According to embodiments, a hybrid linked list descriptor can be either a buffer descriptor or a jump descriptor. A buffer descriptor specifies a block of contiguous memory to be transferred, while a jump descriptor directs the DMA controller to jump to a specific location in main memory in order to retrieve the next descriptor to be executed. As described above, both buffer descriptors and jump descriptors include a “descriptor type” bit field that is utilized by the DMA controller to differentiate between the two type of descriptors. When a DMA controller begins execution of a descriptor, it queries the descriptor type bit field in order to determine whether the descriptor is a buffer descriptor or a jump descriptor.

Splitting conventional descriptors in this fashion allows DMA controller embodiments to navigate through portions of the list as if it were a sequential list, while still providing the ability to utilize jump instructions when required. As illustrated by the right column of FIGS. 6A and 6B, a hybrid linked list does not include the overhead attendant with including jump instructions as part of executing every descriptor. Thus, depending on the number of jump instructions that are required, a DMA controller's efficiency in terms of the percentage of its operations that are data transfers can approach that of a sequential list. And, as illustrated in the right column of FIGS. 6A and 6B, a hybrid linked list still provides all of the jump functionality of a conventional linked list.

A hybrid linked list also provides the ability to improve efficiency by operating on blocks of descriptors. According to some embodiments, and referring back to FIG. 2, contiguous blocks of descriptors can be loaded from the hybrid linked list stored in main data memory and cached in a descriptor cache 290 in order to improve efficiency of the DMA controller 130. Cached descriptor blocks are formed by fetching n descriptors at a time from a hybrid linked list implemented in main data memory. The size of the cached descriptor blocks (n) can be adjusted based on the size of contiguous blocks of buffer descriptors that have been encountered or that are expected to be encountered in the hybrid linked list. The caching of descriptor blocks by the DMA controller 130 allow the controller to efficiently transfer multiple blocks of data without having to interrupt data transfers to retrieve the next descriptor to be executed from the hybrid linked list stored in the main memory 120.

The DMA controller 130 executes the descriptors stored in the descriptor cache 290 sequentially until a jump descriptor is encountered. Prior to executing a descriptor, the DMA controller 130 queries the control field of the descriptor to determine whether it contains a buffer descriptor or a jump descriptor. When a jump descriptor is encountered in the descriptor cache 290, a control unit 285 of the DMA controller flushes the descriptor cache 290. The DMA controller then reloads the cache with n entries from a hybrid linked list stored in main data memory 210, starting at the address specified by the jump descriptor. At this point, the DMA controller 130 resumes execution of the entries in the cache, starting with the first entry, and then proceeding sequentially until all of the entries in the descriptor cache 290 have been processed by the DMA controller 130 or another jump descriptor is encountered. In this manner, embodiments of the hybrid linked list provide the capabilities and advantages of both sequential lists and linked lists. A hybrid linked list can be used to generate the entire spectrum of data structures provided by conventional sequential lists and conventional linked lists.

The user can further benefit from the flexibility provided by a hybrid linked list by configuring each channel of the DMA controller individually based on properties of the data to be transferred by the channel. For example, if it is known that a channel will be used to transfer predominately streaming data, the user can adjust the size of the descriptor blocks to be cached for that channel. Since the transfer of streaming data tends to be comprised of numerous, successive transfers of contiguous blocks of memory, channels that will be used for streaming data transfers can be adjusted to use larger descriptor blocks since relatively infrequent cache flushes will be required. However, when packet data is being transferred, such data tends to consist of smaller blocks of memory that are frequently transferred using pointer-based retrieval patterns such as ping-pong and circular buffers. In this case, a channel can be customized to use smaller descriptor blocks and can even use descriptor block sizes that coincide with the size of the buffers being used by a retrieval patterns that are utilized.

The various hybrid linked list embodiments allow for designing a DMA controller that is especially well suited for transferring streaming data flows, which tend to include a significant number of sequential transfer instructions. The hybrid linked list allows such blocks of sequential instructions to be executed with the efficiency of a conventional sequential list. However, the hybrid linked list still provides all the flexibility of a conventional linked list by allowing for the DMA controller to be programmed to execute a retrieval pattern defined by descriptor data structures. Additionally, the hybrid linked lists provides these capabilities while improving the efficiency provided by a conventional linked list DMA controller. The requirements for a solution that is both flexible and efficient are especially important given the requirements of real-time data transfers in modern devices.

In light of the above description of the embodiments of a hybrid linked list, several distinct advantages over conventional sequential and linked lists are apparent. A hybrid linked list utilizes smaller descriptors than a conventional linked list, and it provides efficiency comparable to that of a sequential list. Unlike a conventional linked list, a hybrid linked list can leverage the fact that it executes descriptors sequentially by caching contiguous blocks of descriptors for faster retrieval. Handling descriptors in blocks also improvise the efficiency of bus transfers by the DMA controller as opposed to processing every descriptor individually. These advantages are provided, all while maintaining the ability to provide the exact functionality of both a linked list and a sequential list. Lastly, hybrid linked lists provide the ability to customize the operation of the DMA controller on a channel-by-channel basis, such that a channel behaves more like a conventional sequential list or a conventional linked list based on the characteristics of the data being transferred.

What is claimed is:

1. A DMA controller comprising:
a control unit configured to perform a data transfer over a bus coupled with the DMA controller, wherein the control unit is further configured to perform a plurality of data transfers using one or more lists of DMA instructions stored in memory, and wherein the control unit will read address information from each list entry, and wherein the address information is determined to be either a buffer pointer or a jump pointer based on at least one bit within each list entry.

2. The DMA controller according to claim 1, further comprising:
a cache of DMA instructions, wherein the control unit loads a block of list entries into the cache and wherein the control unit sequentially executes the DMA instructions stored in the cache.

3. The DMA controller according to claim 2, wherein the control unit flushes the cache when the cache entry to be executed is identified as a jump pointer.

4. The DMA controller according to claim 1, wherein each list entry comprises a first and second bit field, wherein the first bit field stores said address information, and the second bit field stores the one or more bits that indicate whether the address information provides a buffer pointer or a jump pointer.

5. The DMA controller according to claim 1, wherein the buffer pointer comprises a start address that identifies the beginning of a contiguous block of data memory to be transferred by the controller.

6. The DMA controller according to claim 5, wherein the buffer pointer further comprises an end address, and wherein the start address and the end address specify the contiguous block of data memory to be transferred.

7. The DMA controller according to claim 5, wherein the buffer pointer further comprises a buffer depth value that specifies the size of the contiguous block of data memory to be transferred.

8. A method for transferring data by a DMA controller the method comprising:
storing in memory a set of DMA instructions in a list wherein each entry in the list comprises at least one bit that identifies the type of the entry;
retrieving a DMA instruction from the list;
determining the type of the retrieved DMA instruction based on the at least one bit, wherein the DMA instruction is determined to be either a buffer descriptor or a jump descriptor;
if a DMA instruction is determined to be a buffer descriptor, retrieving data specified by an address in memory specified by the buffer descriptor;
if a DMA instruction is determined to be a jump descriptor, jumping to a DMA instruction at a location in the list specified by the jump descriptor.

9. The method according to claim 8, further comprising:
storing a block of list entries in a cache; and
sequentially executing the list entries stored in the cache.

10. The method according to claim 9, further comprising:
flushing the cache when the next cache entry to be executed is identified as a jump descriptor.

11. The method according to claim 8, wherein each list entry comprises a first and second bit field, wherein the first bit field stores either a buffer pointer or a jump pointer, the second bit field stores the one or more bits that indicate whether the first bit field provides a buffer pointer or a jump pointer.

12. The method according to claim 8, wherein the buffer pointer comprises a start address that identifies the beginning of a contiguous block of data memory to be transferred by the controller.

13. The method according to claim 12, wherein the buffer pointer further comprises an end address, and wherein the start address and the end address specify the contiguous block of data memory to be transferred.

14. The method according to claim 12, wherein the buffer pointer further comprises a buffer depth that specifies the size of the contiguous block of data memory to be transferred.

15. A non-transitory computer accessible memory medium storing program instructions, wherein the program instructions are executable to:
store in memory a set of DMA instructions in a list wherein each entry in the list comprises at least one bit that identifies the type of the entry;
retrieve a DMA instruction from the list;
determine the type of the retrieved DMA instruction based on the at least one bit, wherein the DMA instruction is determined to be either a buffer pointer or a jump pointer;
if a DMA instruction is determined to be a buffer pointer, retrieve data specified by an address in memory specified by the buffer pointer;
if a DMA instruction is determined to be a jump pointer, jump to a DMA instruction at a location in the list specified by the jump pointer.

16. The memory medium according to claim 8, wherein the program instructions are further executable to:
store a block of list entries in a cache; and
sequentially execute the list entries stored in the cache.

17. The memory medium according to claim 16, wherein the program instructions are further executable to:
flush the cache when the cache entry to be executed is identified as a jump pointer.

18. The memory medium according to claim 15, wherein each list entry comprises a first and second bit field, wherein the first bit field stores either a buffer pointer or a jump pointer, the second bit field stores the one or more bits that indicate whether the first bit field provides a buffer pointer or a jump pointer.

19. The memory medium according to claim 15, wherein the buffer pointer comprises a start address that identifies the beginning of a contiguous block of data memory to be transferred by the controller.

20. The memory medium according to claim 19, wherein the buffer pointer further comprises an end address, and wherein the start address and the end address specify the contiguous block of data memory to be transferred.

21. The memory medium according to claim 19, wherein the buffer pointer further comprises a buffer depth that specifies the size of the contiguous block of data memory to be transferred.
